(19) United States
(12) Patent Application Publication
(10) Pub. No.: US 2023/0409834 A1
(43) Pub. Date: Dec. 21, 2023

(54) SYSTEM FOR FINE-GRAINED SENTIMENT ANALYSIS USING A HYBRID MODEL AND METHOD THEREOF

(71) Applicant: Graphene AI Technologies Private Limited, Bangalore (IN)

(72) Inventors: Sandeep Katty Sudheendra, Bangalore (IN); Aravind A. J, Thiruvananthapuram (IN); Aamir Syed Altaf, Bangalore (IN); Anirudh Ravikumar, Bangalore (IN); Ranjan Satapathy, Singapore (SG)

(21) Appl. No.: 17/841,055

(22) Filed: Jun. 15, 2022

(51) Int. Cl. G06F 40/30; G06F 40/216; G06F 40/237

(52) U.S. Cl. CPC G06F 40/30; G06F 40/216; G06F 40/237

(57) ABSTRACT

The present invention discloses a system and method for fine-grained sentiment analysis using a hybrid model which is extensible to multiple languages, wherein the system (100) comprises a polarity detection module (101) for continuously detecting the positive sentiments, negative sentiments, and neutral sentiments of one or more sentences in a document. Further, a sentiment classification module (102) predicts the intensity and classifies positive sentiments and negative sentiments into one or more pre-defined sentiment classes, wherein the sentiment classification module (102) provides a reference sentiment interval for the classified sentences in the document. Furthermore, a length-based sentiment scoring module (103) continuously assigns a score to the classified sentences in the document ranging between −s to +s, wherein −s indicates extremely negative sentiment of the sentence and +s indicates extremely positive sentiment of the sentence.

### TECHNICAL FIELD OF THE INVENTION

The present invention discloses a system for fine-grained sentiment analysis using a hybrid model and method thereof. The invention particularly relates to a length-based sentiment scoring system for continuously assigning a score ranging between −s to +s to one or more sentences, wherein −s indicates extremely negative sentiment of the sentence and +s indicates extremely positive sentiment.

### BACKGROUND OF THE INVENTION

Sentiment Analysis is the process of computationally determining whether a document including a phrase, a sentence or a group of sentences is positive, negative, or neutral. The existing technologies available for sentiment analysis employ either rule-based algorithms or deep-learning based algorithms, wherein such algorithms are often not scalable and lack robustness. Additionally, the existing technologies are not applicable to incoming data which is not as per a pre-defined pattern, i.e., the existing technologies do not generalize well across different types of data such as social media, blogs and so on, and different categories of data such as skin care, chocolates, Human Resource (HR) and so on. Due to the above-mentioned drawback, the existing technologies provide inaccurate results when the nature of the incoming data is significantly different from the benchmarked datasets.

The U.S. Pat. No. 9,336,205B2 titled “System and method for analyzing natural language” relates to a computer implemented method for analyzing natural language to determine a sentiment between two entities discussed in the natural language, comprising the following steps: receiving the natural language at a processing circuitry; analyzing the natural language to determine a syntactic representation which shows syntactic constituents of the analyzed natural language and to determine a sentiment score of each constituent; determining which constituents link the two entities; and calculating an overall sentiment score for the sentiment between the two entities by processing the sentiment score of each constituent of the constituents determined to link the two entities.

The U.S. Pat. No. 8,352,405 titled “Incorporating lexicon knowledge into SVM learning to improve sentiment classification” relates to a sentiment classifier for sentiment classification of content. An aspect classifier is configured to classify content as being related to a particular aspect of information, the aspect classifier incorporating at least a portion of the domain specific sentiment lexicon. A polarity classifier is then configured to classify the content classified by the aspect classifier as having one of a positive sentiment of the particular aspect of information, a negative sentiment of the particular aspect of information or as having no sentiment as to the particular aspect of information. The polarity classifier also incorporating at least a portion of the domain specific sentiment lexicon.

Hence, there exists a need for a solution to predict a continuous sentiment value for different types of data that comprise a single phrase, a sentence, or even a large set of sentences irrespective of source(s) of the sentences.

### SUMMARY OF THE INVENTION

The present invention overcomes the drawbacks of the prior art by disclosing a system and method for fine-grained sentiment analysis using a hybrid model, wherein the system comprises a polarity detection module that detects the positive sentiments, negative sentiments, and neutral sentiments of one or more sentences in a document; a sentiment classification module that classifies the sentences in a given document into one or more pre-defined sentiment classes to provide reference sentiment intervals for classifying sentences in the document; and finally, a length-based sentiment scoring module that continuously assigns a score to the classified sentences in the document ranging between −s to +s, wherein −s indicates extremely negative sentiment of the sentence and +s indicates extremely positive sentiment of the sentence.

The present invention provides a continuous sentiment intensity system which is a flexible and multilingual and is capable of accurately predicting a continuous sentiment value for variable kinds of texts that comprise a single phrase, a sentence, a large set of sentences and so on. In addition to being multilingual, the present invention is better compared to the existing technologies in terms of accuracy and robustness. Unlike the existing technologies which are rule based and are not scalable and robust, the present invention is scalable in terms of the sentiment intensity, which is measured on a variable scale, wherein different intensities are assigned to each phrase or sentence.

### BRIEF DESCRIPTION OF THE DRAWINGS:

The foregoing and other features of embodiments will become more apparent from the following detailed description of embodiments when read in conjunction with the accompanying drawings. In the drawings, like reference numerals refer to like elements.

FIG. 1 illustrates a block diagram of a system for fine-grained sentiment analysis using a hybrid model.

FIG. 2 illustrates a method for system for fine-grained sentiment analysis using a hybrid model.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention. The detailed description and drawings are merely illustrative of the invention rather than limiting, the scope of the invention being defined by the appended claims and equivalents thereof. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the software or electrical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The term “document” mentioned in different sections of the specification refers to a single phrase, a sentence, or multiple sentences of variable length, language and sentiment.

The term “affect word(s)” mentioned in different sections of the specification refers to one or more words that convey variable sentiment.

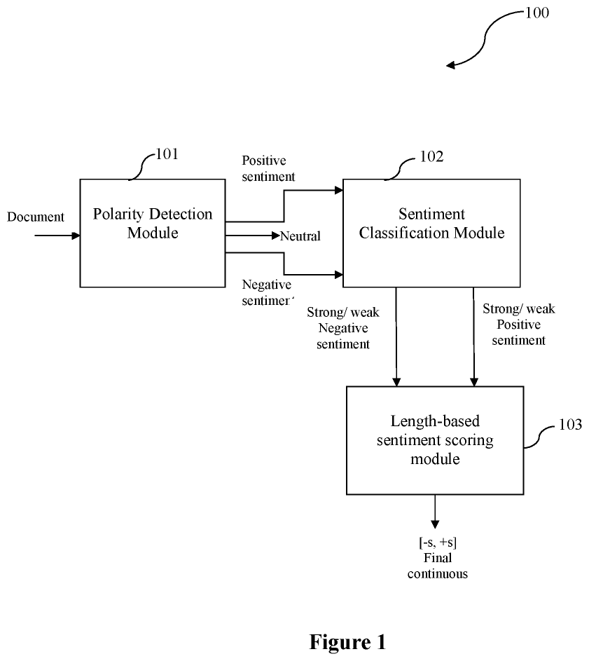

FIG. 1 illustrates a block diagram of a system for fine-grained sentiment analysis using a hybrid model. The system (100) comprises a polarity detection module (101) for detecting the positive sentiments, negative sentiments, and neutral sentiments of one or more sentences in a document. Further, a sentiment classification module (102) predicts the intensity of a positive sentiment and a negative sentiment and classifies the positive sentiments and negative sentiments into one or more pre-defined sentiment classes based on the intensity of the positive and negative sentiments. The sentiment classification module (102) provides a reference sentiment interval for the classified sentences in the document.

Furthermore, the system (100) comprises a length-based sentiment scoring module (103) for continuously assigning a score to the classified sentences in the document ranging between −s to +30 s, wherein −s indicates extremely negative sentiment of the sentence and +s indicates extremely positive sentiment of the sentence. In one embodiment, the length-based sentiment scoring module (103) continuously assigns a sentiment score to the classified sentences from multiple languages.

The system (100) has been explained using the following example as an aid for the purpose of simple understanding. The system (100) calculates the fine-grained sentiment using statistical methods, semantic methods and keyword spotting for textual data. A document is first classified as positive, negative or neutral by the polarity detection module (101), e.g., “I love this Product” is positive; “I got an allergic reaction using this product” is negative and “I received product” is neutral.

Further, the sentiment classification module (102) classifies the polarity classified document as “Strong Positive” or “Weak Positive” and “Strong Negative” or “Weak Negative”. E.g., “I got an allergic reaction using this product” is a “Strong Negative”, whereas “I do not like this product” is a “Weak Negative”.

Subsequently, the sentiment/intensity classified document is passed through the length-based sentiment scoring module (103), wherein the length-based sentiment scoring module (103) may employ a keyword spotting and statistical method to provide final score, e.g., “I got allergic reaction using this product” is assigned a score of −0.78, whereas, “I do not like this product” is assigned a score of “−0.25” in the scaled range of [−1,1].

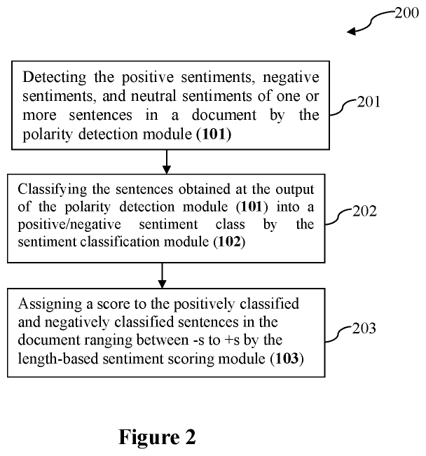

FIG. 2 illustrates a method for system for fine-grained sentiment analysis using a hybrid

model, wherein the method (200) comprises the steps of detecting the positive sentiments, negative sentiments, and neutral sentiments of one or more sentences in a document by the polarity detection module (101) in step (201), wherein a deep learning model is trained to detect and separate the positive sentiments, negative sentiments and neutral sentiments of one or more sentences in the document.

In step (202), the sentences obtained at the output of the polarity detection module (101) are classified into a positive sentiment class or a negative sentiment class by the sentiment classification module (102), wherein the sentiment classification module (102) is trained to predict the intensity of a positive sentiment or a negative sentiment using artificial intelligence and deep learning techniques. In step (204), the length-based sentiment scoring module (103) assigns a score to the positively classified and negatively classified sentences in the document ranging between −s to +s.

The method for assigning a score to the positively classified and negatively classified sentences in the document by the length-based sentiment scoring module (103) comprises the steps of parsing each sentence in the document to find affect words and calculating the cumulative sentiment score based on the type of affect words, wherein a predefined score is assigned to each such word in the lexicon by domain experts and is updated at regular pre-defined intervals with new affect words in the lexicon. Subsequently, the cumulative sentiment score is normalized based on the length of the document, wherein the normalized score is scaled between −1 and +1 based on the observed empirical extremes of the normalized scale. The range of the penultimate score is extended to [−s, +s] by multiplying the penultimate score with “s” thereby resulting in the final score, wherein “s” is a real non-zero number.

The process of assigning a score to the positively classified and negatively classified sentences in the document by the length-based sentiment scoring module (103) is explained by the following example. In a sentence, we notice that not all the words contribute to the sentiment of the sentence, but only a few words do, wherein such words are called affect/emotion words. Every affect word is assigned a value relative to other affect words, e.g., “love” is relatively stronger sentiment than “like” and “allergic reaction” is “stronger sentiment than “do not like”. The method (200) considers individual affect word scores and calculates the overall text score as ratio of number of affect words to length of text. More the number of affect words and shorter the document, stronger the sentiment will be. The scale of sentiment intensity is placed in the range of [−s,s] as a multiplier.

Parsing of affect words entails, finding the affect words in a document using the human-built lexicon and determining the polarity of the sentence. Further, the scores of all the affect words are combined to get raw intensity, wherein the affect words' contribution is normalized as raw intensity is divided by the total number of words present in the sentence to get length-based intensity. Subsequently, statistical methods are applied to scale the intensity based on the classified document, e.g., “I got an allergic reaction using this product” is scaled to be close to −s whereas “I had a great time using this product” is scaled to be close to +s.

The present invention provides a continuous sentiment intensity system which is flexible, extensible to multiple languages and capable of accurately predicting a continuous sentiment value for variable kinds of texts that comprise a single phrase, a sentence, a large set of sentences and so on. In addition to being multilingual, the present invention is better compared to the existing technologies in terms of accuracy and robustness. Unlike the existing technologies which are rule based and are not scalable and robust, the present invention is scalable in terms of the sentiment intensity, which is measured on a variable scale, wherein different intensities are assigned to the document of any given length.

While at least one exemplary embodiment has been presented in the foregoing detailed description, it should be appreciated that a vast number of variations exist.

Reference numbers:

| Components | Reference Numbers |
|---|---|
| System | 100 |
| Polarity detection module | 101 |
| Sentiment classification module | 102 |
| Length-based sentiment scoring module | 103 |

System

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

We claim:

1. A system for fine-grained sentiment analysis using a hybrid model, the system (100) comprising:
a. a polarity detection module (101) for detecting the positive sentiments, negative sentiments, and neutral sentiments of one or more sentences in a document;
b. a sentiment classification module (102) for:
i. predicting the intensity of a positive sentiment and a negative sentiment;
ii. classifying the positive sentiments and negative sentiments into one or more pre-defined sentiment classes based on the intensity of the positive and negative sentiments, wherein the sentiment classification module (102) provides a reference sentiment interval for the classified sentences in the document;
c. a length-based sentiment scoring module (103) for continuously assigning a score to the classified sentences in the document ranging between −s to +s, wherein −s indicates extremely negative sentiment of the sentence and +s indicates extremely positive sentiment of the sentence.

2. The system (100) as claimed in claim 1, wherein the length-based sentiment scoring module (103) continuously assigns a sentiment score to the classified sentences from multiple languages.

3. A method for fine-grained sentiment analysis using a hybrid model, the method (200) comprising the steps of:
a. detecting the positive sentiments, negative sentiments, and neutral sentiments of one or more sentences in a document by the polarity detection module (101), wherein a deep learning model is trained to detect and separate the positive sentiments, negative sentiments and neutral sentiments of one or more sentences in the document;
b. classifying the sentences obtained at the output of the polarity detection module (101) into a positive sentiment class or a negative sentiment class by the sentiment classification module (102), wherein the sentiment classification module (102) is trained to predict the intensity of a positive sentiment or a negative sentiment using artificial intelligence and deep learning techniques;
c. assigning a score to the positively classified and negatively classified sentences in the document ranging between −s to +s by the length-based sentiment scoring module (103).

4. The method (200) as claimed in claim 4, wherein assigning a score to the positively classified and negatively classified sentences in the document by the length-based sentiment scoring module (103) comprising the steps of:
a. parsing each document to find affect words;
b. calculating the cumulative sentiment score based on the type of affect words and a predefined score assigned to each such word in the lexicon;
c. normalizing the cumulative sentiment score based on the length of the document;
d. scaling the normalized score between −1 and +1 based on the observed empirical extremes of the normalized scale;
e. extending the range of the penultimate score to [−s,+s] by multiplying the penultimate score with “s” thereby resulting in the final score, wherein “s” is a real non-zero number.

5. The method (200) as claimed in claim 4, wherein assignment of a pre-defined score to each word in the lexicon is performed by domain experts.

6. The method (200) as claimed in claim 4, wherein the pre-defined score assigned to each word in the lexicon is updated at regular pre-defined intervals with new affect words in the lexicon.
